(19) United States
(12) Patent Application Publication
(10) Pub. No.: US 2020/0393391 A1
(43) Pub. Date: Dec. 17, 2020

(54) METHOD FOR CALIBRATING A RADIOMETRIC DENSITY MEASURING APPARATUS

(71) Applicant: Endress+Hauser SE+Co. KG, Maulburg (DE)

(72) Inventors: Arun Shankar Venkatesh Iyer, Gerlingen (DE); Narcisse Michel Nzitchieu Gadeu, Maulburg (DE); Simon Weidenbruch, Lörrach (DE); Jörn Lange, Schopfheim (DE); Sebastian Eumann, Wittlingen (DE)

(21) Appl. No.: 16/955,870

(22) PCT Filed: Nov. 14, 2018
(86) PCT No.: PCT/EP2018/081176

§ 371 Date: Jun. 19, 2020

(30) Foreign Application Priority Data
Dec. 19, 2017 (DE) 10 2017 130 534.3

(51) Int. Cl. G01N 23/12

(52) U.S. Cl. CPC G01N 23/12; G01N 2223/601; G01N 2223/3037; G01N 2223/635; G01N 2223/616

(57) ABSTRACT

The invention relates to a method for calibrating a radiometric apparatus for determining and/or monitoring density of a medium (6) located in a container (1). The method includes method steps as follows:
determining the mass attenuation coefficient μ_{C} of the empty container (1) with application of the half value thickness N/N₀=0.5 of the radioactive radiation upon passage through the empty container (1) according to the formula: N/N₀˜I/I₀=e^{-μ}^{_{C}}^{ρ1D}, with μ_{C}: mass attenuation coefficient, ρ1: density of the material of the wall of the container, D: distance traveled by the radiation, or inner diameter of the container (1), I: intensity the measured radiation, I₀ intensity of the transmitted radiation, N measured counting rate, N₀ counting rate of the transmitted radiation,
determining the mass attenuation coefficient (μ_{M}) based on the measured intensity, or the counting rate, of the radioactive radiation after passage through the container (1), when a calibration medium of known density (ρ2) is located in the container (1),
ascertaining the dependence of the linear absorption coefficient (μ) on the geometric dimensions of the container (1) based on the two mass attenuation coefficients,
calculating a calibration curve, which shows the dependence of the density of the medium on the count of measured radiation intensity after passage through the container (1).

The invention relates to a method for calibrating a radiometric apparatus for determining and/or monitoring density of a medium located in a container, wherein a transmitting unit and a receiving unit are provided, wherein the transmitting unit transmits radioactive radiation of a predetermined intensity and wherein the receiving unit receives radioactive radiation transmitted by the transmitting unit after passage through the medium, and wherein a control/evaluation unit is provided, which determines density of the medium located in the container based on measured values ascertained by the receiving unit.

Radiometric fill level- or density measurements are used, when usually used measuring methods fail, or can no longer be used. Radiometric density measurements are applied, for example, in the production of aluminum from bauxite and in the measurement of density of slurries, which usually contain pieces of rock, in the context of excavation work in an ocean or river. Often, radiometric, density measurement occurs in conjunction with a flow measurement.

In a radiometric, density measurement, the medium located in a container (tank, silo, pipeline, etc.) is usually irradiated with gamma radiation. The radiation emanates from a gamma source and is sensed by a receiving unit (scintillator), which is so positioned that it receives the gamma radiation transmitted by the transmitting unit after its passage through the medium. Used as gamma source, depending on application, is, for example, a Cs137 or Co60 source. The receiving unit is composed either of plastic or a crystal, a photomultiplier and receiving elements.

The gamma radiation transmitted by the transmitting unit is at least weakened, or attenuated, by the passage through the medium and/or the container. The weakening, or attenuation, of the gamma radiation shows a functional dependence on the density of the medium located in the container. The weakened, or attenuated, gamma radiation strikes the detector material of the detector unit and is there converted into light pulses, which are sensed by a detector, e.g. a photodiode. For determining the density, the number of light pulses are counted, which the gamma radiation produces upon striking the detector material.

The attenuation Fs of the gamma radiation upon passage through the medium can be described via the Lambert-Beer law:

Fs=N/No=e^{-μi·D}

In such case, pi is the linear attenuation coefficient and D the distance traveled by the beam. The distance traveled by the beam corresponds e.g. in the case of a pipeline with clamped-on radiometric, density measuring device to the inner diameter of the pipeline plus twice the value of the thickness of the wall of the container. If the inner diameter of the pipeline is much greater than the thickness of the wall of the pipeline, then the weakening, or attenuation, of the gamma radiation by the material of the wall of the pipeline can be neglected. Alternatively, the attenuation of the gamma radiation by the wall of the container can be experimentally determined in the case of empty container. Due to the radiation striking the detector, this is problematic in practice. Likewise, it is possible to calculate the attenuation of the gamma radiation caused by passage through the material of the wall of the container.

The linear attenuation coefficient depends on the energy of the incoming gamma radiation, the chemical composition of the irradiated medium and the density of the medium. Via introduction of the mass attenuation constant μ, which is derived from the linear attenuation coefficient pi, the dependence of the attenuation of the gamma radiation on the properties of the medium can be almost completely eliminated. Under ideal conditions, the mass attenuation is constant independent of the density and the character of the medium and, thus, only depends on the energy of the incoming gamma radiation. This situation can be explained by the fact that the gamma radiation applied for density measurement lies in an energy range from 0.5 to 0.6 MeV. In this energy range, the Compton effect, thus, the inelastic scattering of photons on the electrons of the scattering medium, is the dominant effect. As a result, the mass attenuation constant μ in the case of constant energy of the radiated photons interacting with the medium is a constant and depends only on the density ρ of the medium. Thus, μ=μi/ρ and N=No e^{-μ·ρ·D}. This leads to:

ln(N/No)=1/(μ·ρ·D).

Since the distance D traveled by the beam in a predetermined container is a calculable, constant variable and since the mass attenuation constant is constant, ln(N/No) is proportional to 1/ρ.

In order to enable a reliable radiometric determining of the density of a medium located in a container, a two point calibration is performed. For this, the container is filled in a first step with a first medium of known density ρ1. The medium is irradiated with gamma radiation, and the corresponding counting rate N1 determined. In a second step the container is filled with a second medium of known density ρ2, wherein the density of the second medium differs from the density of the first medium, preferably as much as possible. The counting rate N2 is determined. Based on the ascertained measured values (counting rates) and the known variables (ρ1, ρ2), the mass attenuation constant μ is calculated.

Based on the ascertained variables, the calibration curve of the radiometric, density measuring device is ascertained and stored in the density measuring device.

Via the known method, a radiometric, density measuring device can be individually calibrated. However, this two point calibration involves a significant amount of work and expense. Often, the container, tank, silo or pipeline has a significant volume, so that the media applied for calibrating have to be supplied in considerable amounts. While calibrating with water as calibration medium for the upper density range is still relatively without problem, the filling with the second medium of lower density, e.g. oil, is often only possible with considerable effort. In this connection, measuring locations, which are located e.g. in difficulty accessible, desert regions, are a particular problem. Therefore, the calibration curve is often determined based on a measurement of the counting rate for only one medium (one point calibration). Used as second mass attenuation coefficient, which is needed for calculating the calibration curve, is a standard value of 7.7 mm²/g. This value is empirically derived. In this way, indeed, the calibration effort is cut in half, however, this happens, in particular cases, accompanied by loss of accuracy of measurement of the radiometric, density measuring device.

Even the known two point calibration, thus, the determining of the mass attenuation coefficient based on determining the attenuation of gamma radiation upon passage through two media of known, different densities, is not very reliable, since the influence of the density of the two media on the mass attenuation coefficient is in many cases significantly less than the influence of the geometric dimensions of the container and the geometric arrangement of the receiving- and transmitting units.

An object of the invention is to provide a simple method for precise calibrating of a radiometric, density measuring device.

The object is achieved by method steps as follows:
calculating the mass attenuation coefficient μ_{C} of the empty container with application of the half value thickness N/N₀=0.5 of the radioactive radiation upon irradiating the empty container according to the formula: N/N₀˜I/I₀=0.5=e−μ^{-μ}^{_{C}}^{·ρ}^{_{C}}^{·2d}, with ρ_{C}: density of the material of the container wall, D: distance traveled by the radiation, N: counting rate after irradiating the container, N₀: counting rate of the gamma radiation transmitted from the gamma source,
determining the mass attenuation coefficient μ_{M} of the medium based on the measured intensity, or the counting rate, of the radioactive radiation after irradiating the container, when a calibration medium of known density ρ_{M} is located in the container,
ascertaining the dependence of the linear absorption coefficient μ on the geometric dimensions of the container based on the two ascertained mass attenuation coefficients,
calculating a calibration curve, which shows dependence of density of the medium on measured radiation intensity, or the measured counting rate, after passage through the container.

The method of the invention provides, thus, a one point calibration for calibrating a radiometric, density measuring device: experimentally, the counting rate of the gamma radiation of the used gamma source after the radiation is passed through the container filled with a medium of known density is ascertained. The second density value, which is required for determining the mass attenuation coefficient, is ascertained by means of the half value thickness N/No=0.5. By comparison with experimental measured values, which were won via two point calibration, it has been found that the method of the invention delivers very good results.

The intensity of the gamma radiation decreases exponentially with penetration depth into the irradiated medium. The half value thickness designates the distance traveled by the gamma radiation in the material/medium, in the case of which the intensity of the gamma radiation has halved as a result of the interaction (essentially Compton scattering) with the material/medium. The half value thickness depends on the wavelength of the gamma radiation and on the atomic number of the irradiated material/medium. In the case of the solution of the invention, the irradiated material is essentially the material of the wall of the container, since the attenuation of gamma radiation in air is negligibly small. An experimental ascertaining of the intensity of the radiation is often excluded in the case of empty container, since, in this case, the detector would receive too much radiation. However, naturally, an appropriate experimental determining of the counting rate ratio could be utilized in connection with the invention.

Preferably, the mass attenuation coefficient of the empty pipeline or tank, when the wall is made of a material of the density ρ1, is calculated according to the following formula: μ_{C}=0.693/ρ1*2d, wherein d is the thickness of the wall of the pipeline or tank.

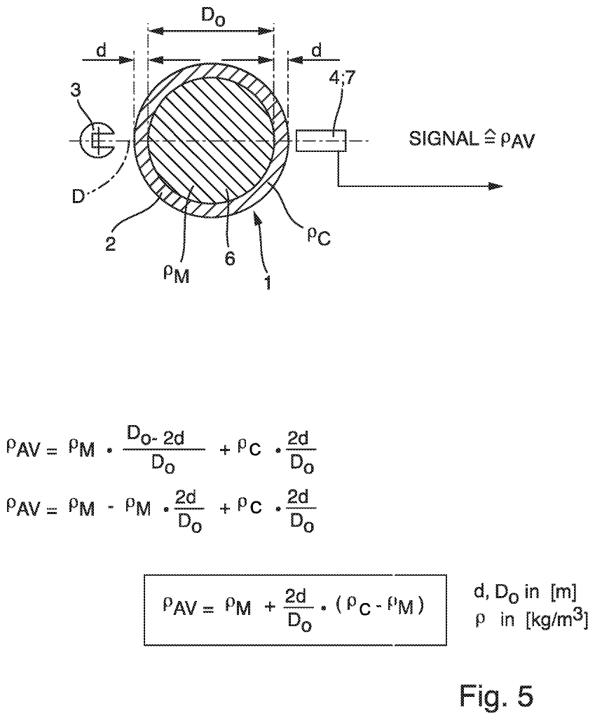

This calculation represents an approximation. The correct formula for the average density ρ_{AV} is, in the case of a cylindrical container with the inner diameter D₀ and the thickness of the container wall d, as follows—see FIG. 5:

$${ρ}_{AV} = {ρ}_{M} + \frac{2 d}{{D}_{0}} ( {ρ}_{C} - {ρ}_{M} )$$

with ρ_{C}: density of the container wall, ρ_{M}: density of the medium located in the container. Air has a density of about ρ_{M}=0.0012 kg/m³, steel has a density of about 8000 kg/m³. The container has, for example, an inner diameter of 1 m, the container wall is 0.01 m thick.

If the container is empty, i.e. filled with air, then the average density can be calculated according to the following formula:

$${ρ}_{AV} = \frac{2 d}{{D}_{0}} {ρ}_{c}$$

In an advantageous, further development of the density measuring apparatus of the invention, the experimental determining of the counting rate occurs with a calibration medium, e.g. water with a known density of approximately 1 kg/m³, located in the container. Since, in this case, d<<D₀, the average density ρ_{AV} is approximately the density of the medium ρ_{M}.

N/N₀=e^{-μ·}^{_{M}}^{·D}^{₀}.

Usually, the container is a pipeline or a tank. Since gamma radiation also passes through solids, the transmitting unit and the receiving unit are secured on the outer wall. They are so positioned relative to one another that the container is irradiated perpendicularly to the longitudinal axis of the pipeline, inclined to the longitudinal axis of the pipeline or in parallel with the longitudinal axis of the pipeline. The actual arrangement is selected as a function of the particular case of application.

In order to obtain optimal measurement results, the receiving unit is so embodied and positioned relative to the transmitting unit that the sensitive components of the receiving unit are struck by the radiation passing through the container.

The invention will now be explained in greater detail based on the appended drawing, the figures of which show as follows:

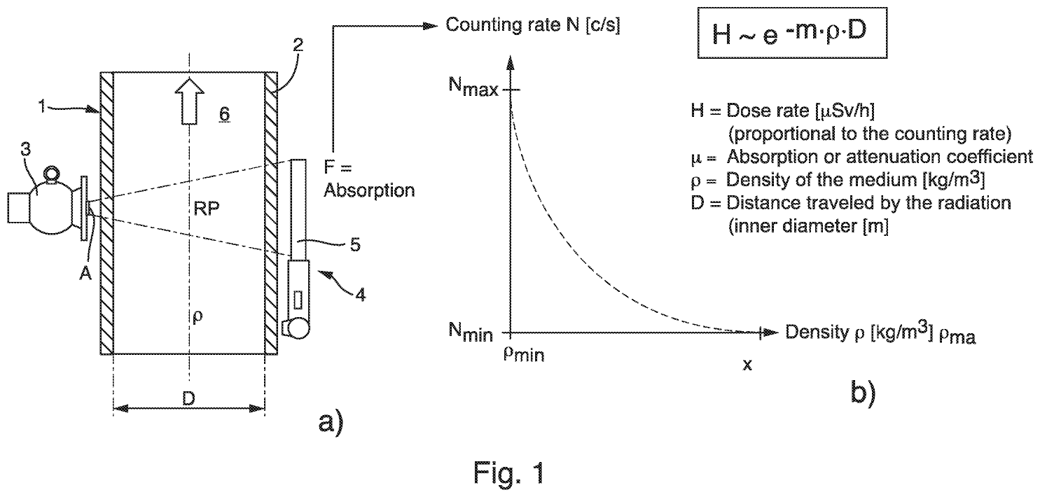

FIG. 1a a schematic view of an arrangement for radiometrically determining the density of a medium,

FIG. 1b a schematic view of a graph, which shows dependence of counting rate on density,

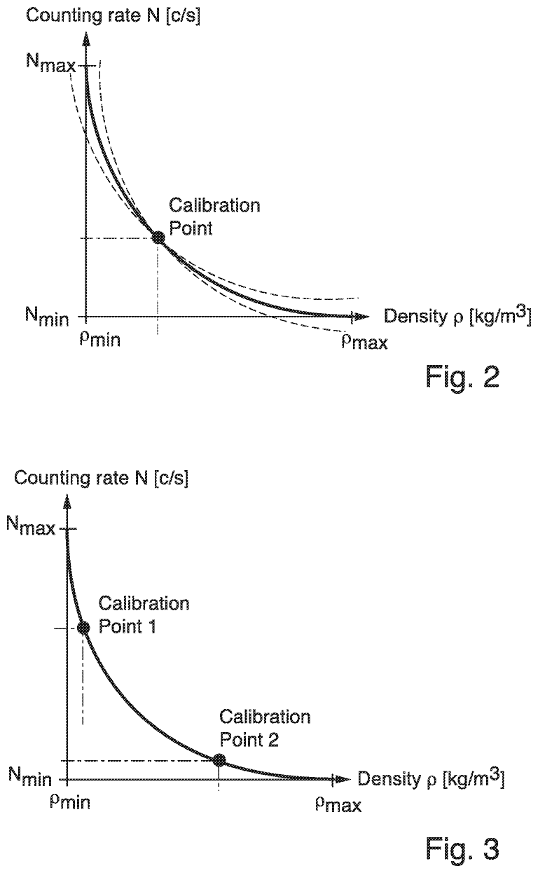

FIG. 2 a graph of the density-calibration curve in the case of a one point calibration,

FIG. 3 a graph of the density-calibration curve in the case of a two point calibration,

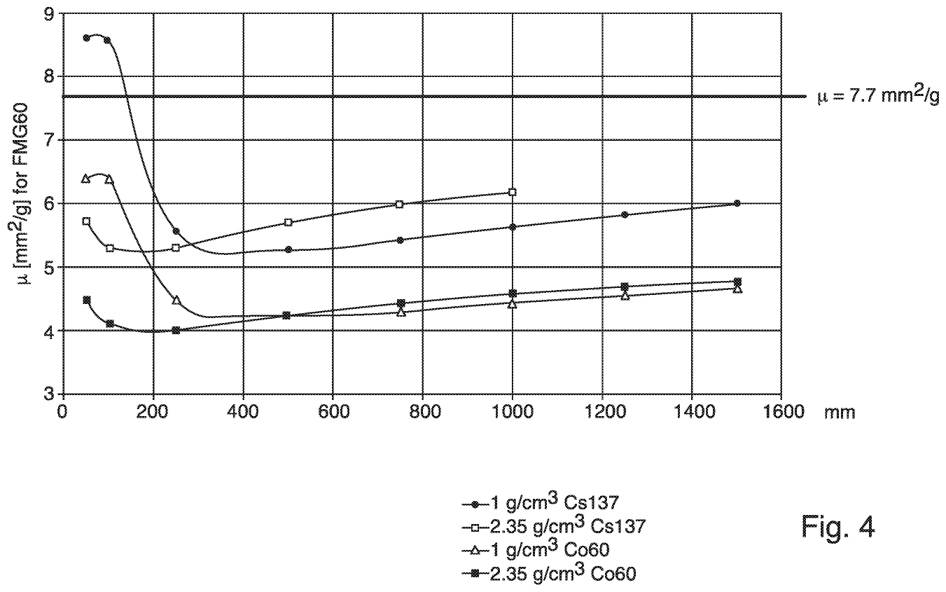

FIG. 4 a graph of a number of curves, which show the dependence of the “mass attenuation constant” on the diameter of a container, when different radiation sources are utilized and when media with different densities are placed in the container, and

FIG. 5 schematic view of the distance traveled by the gamma radiation through a tubular container.

FIG. 1a shows a schematic view of an arrangement for radiometrically determining the density of a medium 3 located in a container 1, here a pipeline. The transmitting unit 3 with the gamma source and the receiving unit 4 are arranged on opposite surface regions of the pipeline 1. Both components 3, 4 are secured externally on the pipeline 1 via a clamping mechanism (not shown).

The gamma source is housed such that the gamma radiation escapes from the transmitting unit 3 only in the region of the exit area A. The gamma radiation irradiates the container 1 with the medium 6 located therein, whose density ρ is to be determined, on the indicated radiation path RP. The gamma radiation attenuated as a result of the Compton effect is received by the receiving unit 4. Based on the intensity, i.e. based on the counting rate of the receiving unit 4, the evaluation unit 7 determines the density of the medium 6 located in the container 1. Corresponding radiometric, density measuring arrangements are manufactured and sold by the applicant.

As already mentioned above, the arrangements of transmitting unit 3 and receiving unit 4 relative to the container 1 can be differently embodied.

FIG. 1b shows a schematic view of a graph of the counting rate N as a function of the density ρ of the medium 6. The absorption F of the gamma radiation on the radiation path RP through a medium 6 can be described via the Lambert-Beer law in the form of an e-function. The absorption F corresponds to the ratio of counting rate of the gamma radiation after passage through the medium 6 to counting rate No of the gamma radiation transmitted from the gamma source at the exit opening A. The counting rate N is given in counts (number of events) per second (c/sec). The ratio of these two counting rates is proportional to the dose rate H, which is given in μSv/h. Contained in the e-function are μ the absorption- or attenuation coefficient, ρ the density of the medium [kg/m³] and D [m] the distance traveled on the radiation path RP through the medium 6. In the illustrated case, the distance traveled on the radiation path RP corresponds to the inner diameter D of the pipeline 1.

FIG. 1 b shows the difference ΔFs between the maximum arising attenuation and the minimum arising attenuation, which can be described by the ratio of maximum counting rate Nₘₐₓ to minimum counting rate Nₘᵢₙ of the gamma radiation as a function of the density p. In the case of maximum density ρₘₐₓ, the counting rate N/No is approximately zero, while in the case of minimum density ρₘᵢₙ, the counting rate essentially equals the counting rate No of the gamma radiation transmitted from the gamma source. The following mathematical relationships hold:

$$Δ F s = \frac{{N}_{max}}{{N}_{min}} = {e}^{μ \cdot D \cdot ( {ρ}_{max} - {ρ}_{min} )} and$$

$$\frac{{N}_{min}}{{N}_{max}} = {e}^{- μ \cdot D \cdot ( {ρ}_{min} - {ρ}_{max} )}$$

In order to be able to provide reliable radiometric, density measurements, the radiometric measuring arrangement must be calibrated. Shown in FIG. 2 are a one point calibration and the calibration- and subsequent measurement error associated therewith. The calibration error results from the fact that in the case of a one point calibration the slope of the exponential function is not defined. A reliable measurement in the case of the one point calibration is only assured, when the density measured value to be determined for the medium 6 lies as near as possible to the calibration point. For calculating the calibration point, the standard absorption coefficient μ was used. This has a constant value of 7.7 mm²/g.

FIG. 3 shows the attenuation curve (counting rate as a function of the density of the irradiated medium) in the case of a two point calibration. As a result of the two relatively widely separated calibration points, the slope of the attenuation curve is defined. Therefore, in the case of a two point calibration, a high accuracy of measurement is assured over the total density range.

It was stated above that the the mass attenuation constant under ideal conditions is (theoretically) independent of the density and the character of the medium and only dependent on the energy of the incoming gamma radiation. This assumption is not quite correct. Shown registered in FIG. 4 are a number of curves, which reflect the dependence of the mass attenuation coefficient on the diameter of a container 1. Constant in the case of all shown values is only the above mentioned standard mass attenuation constant. All other mass attenuation constants show a dependence on the diameter of the container 1.

It is clearly evident that, in the case of the same density measuring device type (here FMG 60), the curves for equal density of the medium 6 are similar but shifted relative to one another (compare curves 1 and 3 and curves 2 and 4). In the case of application of the same radiation source, the curves are shifted parallel relative to one another as a function of the density of the medium after a diameter of about 300 mm. In the region of smaller diameter of the container 1, or the pipeline, the attenuation coefficient falls relatively rapidly, while from a diameter of greater than 300 mm it is dependent essentially on the intensity of the radiation source of the transmitting unit 3 and the density of the medium 6 located in the container 1. Nevertheless, the curves also show above a diameter of 300 mm a—though small—linear dependence on the diameter of the container and, thus, on the irradiated medium.

In actual applications, there is another influencing variable: In most cases of application, the medium, whose density is to be measured, is composed of a mixture of different components (i.e., the medium is a slurry). Therefore, the mass attenuation “constant” of a medium has no constant value, but, instead, it assumes a value, which is composed of a weighted sum of different components of the medium. In most cases of application, the mass attenuation constant is, consequently, not available and it is difficult to establish a constant value for a mixture. Often, one uses the fallback option of the above mentioned, standard mass attenuation constant.

### LIST OF REFERENCE CHARACTERS

1 container
2 wall of the container
3 transmitting unit with gamma source
4 receiving unit
5 sensitive component
6 medium
7 evaluation unit

1. Method for calibrating a radiometric apparatus for determining and/or monitoring density of a medium (6) located in a container (1), wherein a transmitting unit (3) and a receiving unit (4) are provided, wherein the transmitting unit (3) transmits radioactive radiation of a predetermined intensity and wherein the receiving unit (4) receives radioactive radiation transmitted by the transmitting unit (3) after passage through the medium (6), and wherein a control/evaluation unit (7) is provided, which determines density of the medium (6) located in the container (1) based on intensity measured by the receiving unit (4), wherein the method comprises method steps as follows:
determining the mass attenuation coefficient μ_{C} of the empty container (1) with application of the half value thickness N/N₀=0.5 of the radioactive radiation upon passage through the empty container (1) according to the formula: N/N₀˜I/I₀=e^{-μ}^{_{C}}^{·ρ1D}, with μ_{C}: mass attenuation coefficient, ρ1: density of the material of the wall of the container, D: distance traveled by the radiation, or inner diameter of the container (1), I: intensity of the measured radiation, I₀ intensity of the transmitted radiation, N measured counting rate, N₀ counting rate of the transmitted radiation,
determining the mass attenuation coefficient (μ_{M}) based on the measured intensity, or the counting rate, of the radioactive radiation after passage through the container (1), when a calibration medium of known density (ρ2) is located in the container (1),
ascertaining the dependence of the linear absorption coefficient (p) on the geometric dimensions of the container (1) based on the two mass attenuation coefficients,
calculating a calibration curve, which shows the dependence of the density of the medium on the count of measured radiation intensity after passage through the container (1).

2. Method as claimed in claim 1,
wherein the mass attenuation coefficient of the container (1) is calculated according to the following formula: μ_{C}=0.693/ρ1 D, wherein 0.693=ln 0.5.

3. Method as claimed in claim 1 or 2,
wherein water is used as calibration medium.

4. Method as claimed in claim 1, 2 or 3,
wherein the transmitting unit (3) and the receiving unit (4) are so positioned relative to one another that the container (1) is irradiated perpendicularly to the longitudinal axis of the container (1), inclined to the longitudinal axis of the container (1) or in parallel with the longitudinal axis of the container (1).

5. Method as claimed in at least one of the preceding claims,
wherein a pipeline is used as container (1), and wherein the transmitting unit (3) and the receiving unit (4) are secured on opposite surface regions of the pipeline.

6. Method as claimed in claim 4 or 5,
wherein the receiving unit (4) is so embodied and positioned that the sensitive components (5) of the receiving unit (4) are struck by the radiation.
